(19) United States
(12) Patent Application Publication
(10) Pub. No.: US 2024/0396683 A1
(43) Pub. Date: Nov. 28, 2024

(54) COMMUNICATION METHOD AND RELATED DEVICES

(71) Applicant: SPREADTRUM COMMUNICATIONS (SHANGHAI) CO., LTD., Shanghai (CN)

(72) Inventors: Huayu ZHOU, Shanghai (CN); Zhenzhu LEI, Shanghai (CN); Zhengang PAN, Shanghai (CN)

(21) Appl. No.: 18/686,273

(22) PCT Filed: Dec. 30, 2021
(86) PCT No.: PCT/CN2021/143058

§ 371 Date: Feb. 23, 2024

(30) Foreign Application Priority Data
Aug. 24, 2021 (CN) 202110977690.6

(51) Int. Cl. H04L 5/00; H04W 74/0808

(52) U.S. Cl. CPC H04L 5/0048; H04L 5/0073; H04W 74/0808

(57) ABSTRACT

Disclosed are a communication method and related devices. The method includes the following. A first reference signal is received. The first reference signal occupies M symbols, the M symbols are spaced apart by N symbols, M is an integer greater than 0, and N is an integer greater than or equal to 0. By means of the technical solution provided in the present disclosure, a periodic reference signal on a carrier or a cell is optimized, thereby saving energy and reducing consumption.

### CROSS-REFERENCE TO RELATED APPLICATION(S)

This application is a National Stage of International Application No. PCT/CN2021/143058, field Dec. 30, 2021, which claims priority to Chinese Patent Application No. 202110977690.6 filed Aug. 24, 2021, the entire disclosure of which are hereby incorporated by reference.

### TECHNICAL FIELD

The present disclosure relates to the field of wireless communication technologies, and in particular, to a communication method and related devices.

### BACKGROUND

In the fifth generation mobile communication technology (5G), due to abundance of band resources, such as bands of 1 GHz, 2 GHZ, 4 GHZ, 26 GHz, etc., the network device may disable carriers or cells corresponding to some bands as far as possible for network energy saving in the case of low network load. Even if the network load is low and some carriers or cells do not need to carry data, such carriers or cells still need to carry a reference signal to support access and mobility measurement of a user equipment (UE). Therefore, how to optimize reference signals on carriers or cells for network energy saving is a problem to be solved urgently.

### SUMMARY

According to a first aspect, the present disclosure provides a communication method. The method may be applied to a terminal device, and may also be applied to a module (for example, a chip) in the terminal device. The method includes the following. A terminal device receives a first reference signal, where the first reference signal occupies M symbols, The M symbols are spaced apart by N symbols, M is an integer greater than 0, and N is an integer greater than or equal to 0.

In a second aspect, the present disclosure provides a communication system. The communication system includes at least one terminal device and at least one network device. When the at least one terminal device and the at least one network device run in the communication system, the communication system is configured to execute any method in the first aspect.

In an third aspect, the present disclosure provides a non-transitory computer-readable storage medium. The computer-readable storage medium stores a computer instruction. When a computer program or the computer instruction is running, the method in the first aspect and any possible embodiment of the first aspect.

### BRIEF DESCRIPTION OF THE DRAWINGS

FIG. 1 is a schematic structural diagram of a network architecture provided in an embodiment of the present disclosure.

FIG. 2 is a schematic flowchart of a communication method provided in an embodiment of the present disclosure.

FIG. 3 is a schematic structural diagram of a communication device provided in an embodiment of the present disclosure.

FIG. 4 is a schematic structural diagram of another communication device provided in an embodiment of the present disclosure.

FIG. 5 is a schematic structural diagram of still another communication device provided in an embodiment of the present disclosure.

FIG. 6 is a schematic structural diagram of a terminal device provided in an embodiment of the present disclosure.

### DETAILED DESCRIPTION

Terms used in embodiments of the present disclosure are only used to explain specific embodiments of the present disclosure, rather than intended to limit the present disclosure. Definitions of possible technical terms in the embodiments of the present disclosure will be given first.

### (1) Synchronization Signal/Physical Broadcast Channel (SS/PBCH) Block in Release-15 (Rel-15) NR

Specifically, in Rel-15 NR, synchronization signals and broadcast channel signals are transmitted as SS/PBCH blocks. Further Rel-15 NR also introduces functions such as beam sweeping. A SS/PBCH block may include a primary synchronization signal (PSS), a secondary synchronization signal (SSS) and a physical broadcast channel (PBCH) signal. Each SS/PBCH block can be regarded as a resource corresponding to one beam in the beam sweeping. Multiple SS/PBCH blocks may form a synchronization signal burst. The synchronization signal burst can be regarded as a relatively concentrated resource containing multiple beams. Multiple synchronization signal burst may form a synchronization signal burst set (SS-burst-set). The SS/PBCH blocks are transmitted on different synchronization signal bursts repeatedly to complete the beam sweeping process. Through the training of the beam sweeping, a UE can determine which beam receives a strongest signal.

Time-domain locations of L numbers of SS/PBCH blocks within a 5 millisecond (ms) window are fixed. Indexes of the L numbers of SS/PBCH blocks are put in a successive order in the time-domain locations, from 0 to (L−1), and L is a positive integer. Therefore, the transmission time of the SS/PBCH block within this 5 ms window is fixed, and the index is also fixed.

### (2) Remaining Minimum System Information (RMSI) in Rel-15 NR

RSMI in Rel-15 NR is similar to a system information blocks 1 (SIB1) in LTE, which includes main system information except a master information block (MIB). The RMSI may also be referred to as the SIB1. The RMSI is carried by a physical downlink shared channel (PDSCH), and the PDSCH is scheduled through a physical downlink control channel (PDCCH). A PDSCH carrying a RMSI is generally referred to as a RMSI PDSCH, and a PDCCH for scheduling the RMSI PDSCH is generally referred to as a RMSI PDCCH.

In general, a search space set may include properties such as monitoring occasions and a search space type of the PDCCH. The search space set is generally associated to a control resource set (CORESET), and the CORESET may include properties such as a frequency domain resource and a duration of the PDCCH.

A search space set where a RMSI PDCCH is located is generally referred to as a Type0-PDCCH search space set, and is configured by a MIB in general. The Type0-PDCCH search space set is called as a search space 0 (or a search space set 0) when configured by a radio resource control (RRC) in switching, and a CORESET associated to the search space 0 is called a CORESET0. In addition to the search space set of the RMSI PDCCH, other common search spaces or common search spaces sets can be determined as the same as the search space set 0 by default, such as a search space set of an OSI PDCCH (Type0A-PDCCH search space set), a search space set of a random access response (RAR) PDCCH (Type1-PDCCH search space set), a search space set of a paging PDCCH (Type2-PDCCH search space set), and so on. In general, the above-mentioned common search spaces or common search spaces sets can be reconfigured.

A monitoring occasion of a RMSI PDCCH is associated with an SS/PBCH block. A UE may obtain the association based on a monitoring occasion table of the RMSI PDCCH. During an initial access process, when the UE finds a certain SS/PBCH block, the UE may determine a time-domain location of a RMSI PDCCH associated with the SS/PBCH block (a starting symbol index or a first symbol index) based on a row index of the table indicated by a PBCH, detect the RMSI PDCCH, and receive and decode the RMSI PDSCH based on the RMSI PDCCH scheduling.

### (3) Timing Information

A UE may need to obtain timing information through an SS/PBCH block. The timing information which may also be referred to as frame timing information or half-frame timing information is generally used for indicating a timing of a frame or a half-frame corresponding to a detected synchronization signal. After obtaining the frame timing information, the UE may obtain a complete timing information of a cell corresponding to the SSB through a system frame number (SFN). After obtaining the half-frame timing information, the UE may obtain the complete timing information of the cell corresponding to the SSB through a half-frame indication (the first half-frame or the last half-frame) and the SFN.

In general, a UE may obtain a timing information of 10 ms by obtaining an SSB index. In a licensed spectrum, the SSB index is related to L numbers of candidate locations of the SSB. When L=4, the lower 2 numbers of bits (2 LSBs) of the SSB index are carried in a physical broadcast channel demodulation reference signal (PBCH DMRS); when L>4, three least significant bit (3 LSBs) of the SSB index are carried in the PBCH DMRS; and when L=64, three most significant Bit (3 MSBs) of the SS/PBCH block index are carried in a PBCH payload or a MIB.

### (4) Initial Access of NR

In the NR, generally, a UE may support a bandwidth of 100 MHz. During an initial access process, the UE may detect the PSS/SSS/PBCH in the SSB blindly, and obtain the MIB and time index information carried in the PBCH. The UE may obtain, through the information in the MIB, a configuration of a CORESET (may be called CORESET0) and a search space set (may be called search space set 0) or scheduling a SIB1, and further, the UE may monitor and schedule the Type0-PDCCH of the PDSCH for carrying the SIB1, and decode the SIB1. Since the bandwidth of the CORESET0 is set through a table in the PBCH, the maximum bandwidth of CORESET0 is implicitly defined in a protocol. Further, the protocol stipulates that a frequency domain resource of the PDSCH for carrying the SIB1 is within the bandwidth of CORESET0 (PRB), therefore, the maximum bandwidth of the PDSCH for carrying the SIB1 is also implicitly defined in the protocol. In fact, in an idle state, the UE works in an initial active downlink (DL) bandwidth part (BWP), and a frequency-domain location of the initial active DL BWP is the same as a frequency-domain location of the CORESET0 by default (non-default, the frequency-domain location of the initial active DL BWP can be modified to cover the frequency-domain location of the CORESET0 through signaling), and therefore the maximum bandwidth of the initial active DL BWP is implicitly defined in the protocol.

For some carriers or cells, they are only used for data load balancing, do not need to carry the MIB and SIB, and therefore do not need to carry the SS/PBCH BLOCK. These carriers or cells may be referred to as non-anchor carriers or cells, and on the contrary, a few carriers or cells need to carry the MIB and the SIB to support cell search and system information transmission, and these carriers or cells may be referred to as anchor carriers or cells. A non-anchor carrier or cell may still support paging, random access, RRM measurement, and so on, and therefore needs to bear a periodic reference signal, so as to support a user equipment (UE) to perform time/frequency tracking and RRM measurement.

Network energy saving (also referred to as network power saving) is a problem concerned by operators as well as vendors, and network energy saving is beneficial to reducing operating expense (OPEX) and protecting the environment. In a 5G network, due to abundance of band resources, such as bands of 1 GHZ, 2 GHZ, 4 GHZ, and 26 GHz, non-anchor carriers or cells can be disabled as far as possible to save energy in the case of low network load. Even if the network load is low and some carriers or cells do not need to carry data, such carriers or cells still need to carry a reference signal to support access and mobility measurement of a user equipment (UE). Therefore, how to optimize reference signals on carriers or cells for network energy saving is a problem to be solved urgently.

The technical problem to be solved by embodiments of the present disclosure may include the following. In embodiments of the present disclosure, a reference signal occupies one or more symbols, when the reference signal occupies multiple symbols, the multiple symbols are spaced apart by one or more symbols, so that the reference signal has a shorter duration and fewer times of transition (transition between transmission and sleep), that is, a simplified reference signal may be concentrated in time as much as possible during beam sweeping, thereby saving energy and reducing consumption.

Embodiments of the present disclosure provide a communication method and related devices. With the method, a periodic reference signal on a carrier or a cell is optimized, so as to save energy and reduce consumption.

According to a first aspect, the present disclosure provides a communication method. The method may be applied to a terminal device, and may also be applied to a module (for example, a chip) in the terminal device. The method includes the following. A terminal device receives a first reference signal, where the first reference signal occupies M symbols, The M symbols are spaced apart by N symbols, M is an integer greater than 0, and N is an integer greater than or equal to 0.

In the solution provided in the present disclosure, a non-anchor carrier or cell supports paging, random access, radio resource management (RRM) measurement, etc., and needs to carry a periodic reference signal, so as to support synchronization (time/frequency tracking) and mobility measurement (such as RRM measurement) of a terminal device. In embodiments of the present disclosure, a reference signal is simplified, so that the reference signal has a relatively short duration and a relatively fewer times of transition (transition between transmission and sleep), that is, the simplified reference signal can be concentrated in time as much as possible during beam sweeping, thereby saving energy and reducing consumption.

In a possible embodiment, M=2, and N=1.

In the solution provided in the present disclosure, a reference signal beam is two symbols of a reference signal separated by a symbol. Separation by a symbol may facilitate frequency tracking. When frequency offset estimation is performed on the two symbols (i.e., two columns) of the reference signal, there is a certain symbol interval in the reference signal, in this way, noises of channels corresponding to the two symbols of the reference signal are irrelevant and may be cancelled out when a self-correlation algorithm is performed.

In a possible embodiment, in a slot, symbol indexes of the first reference signal are 2 and 4, 5 and 7, 8 and 10, or 11 and 13, where a symbol index starts from 0. In this way, four first reference signals, that is, four beams, can be placed in one slot.

A symbol index of the reference signal starts from 2, and the 0th symbol (with an index of 0) and the first symbol (with an index of 1) can be used for the terminal device to receive a physical downlink control channel (PDCCH).

In a possible embodiment, in a slot, symbol indexes of the first reference signal are 0 and 2, 3 and 5, 6 and 8, or 9 and 11, where a symbol indexes starts from 0. In this way, four first reference signals, that is, four beams, can be placed in one slot.

In the solution provided in the present disclosure, a symbol index of a reference signal starts from 0, and a twelfth symbol (with an index of 12) and a thirteenth symbol (with an index of 13) may be used for a terminal device to send an uplink signal.

In a possible embodiment, there is a second reference signal between two symbols of the first reference signal.

In the solution provided in the present disclosure, in order to use one symbol between two symbols of a reference signal, another reference signal of one symbol may be sent on the symbol. In this way, there is no empty symbol between two symbols of the reference signal.

In a possible embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal is 8 and 10, and the symbol index of the second reference signal is 9; or the symbol indexes of the first reference signals are 11 and 13, and the symbol index of the second reference signal is 12; where a symbol index starts from 0. In this way, four first reference signals, that is, four beams, can be placed in one slot.

In the solution provided in the present disclosure, a symbol index of a reference signal starts from 2, and the 0th symbol (with an index of 0) and the first symbol (with an index of 1) can be used for a terminal device to receive a PDCCH.

In a possible embodiment, in a slot, symbol indexes of the first reference signal are 0 and 2, and a symbol index of the second reference signal is 1; or the symbol indexes of the first reference signal are 3 and 5, and the symbol index of the second reference signal is 4; or symbol indexes of the first reference signal are 6 and 8, and the symbol index of the second reference signal is 7; or the symbol indexes of the first reference signal are 9 and 11 and the symbol index of the second reference signal is 10; where a symbol index starts from 0. In this way, four first reference signals, that is, four beams, can be placed in one slot.

In the solution provided in the present disclosure, a symbol index of a reference signal starts from 0, and a twelfth symbol (with an index of 12) and a thirteenth symbol (with an index of 13) may be used for a terminal device to send an uplink signal.

In a possible embodiment, in a slot, symbol indexes of the first reference signal are 3 and 5, 6 and 8, or 9 and 11, where a symbol index starts from 0. In this way, three first reference signals, that is, three beams, may be placed in one slot.

In the solution provided in the present disclosure, a symbol index of a reference signal starts from 3, and the 0th symbol (with an index of 0), the first symbol (with an index of 1) and the second symbol (with an index of 2) can be used for a terminal device to receive a PDCCH, and correspond to three beams of three reference signals, so as to achieve better coexistence of the reference signals and the PDCCH. The twelfth symbol (with an index of 12) and the thirteenth symbol (with an index of 13) can be used for the terminal device to send an uplink signal.

In a possible embodiment, in a slot, symbol indexes of the first reference signal are 3 and 5, and a symbol index of the second reference signal is 4; or the symbol indexes of the first reference signal are 6 and 8, and a symbol index of the second reference signal is 7; or the symbol indexes of the first reference signal are 9 and 11, and the symbol index of the second reference signal is 10; where a symbol index starts from 0. In this way, three first reference signals, that is, three beams, may be placed in one slot.

In a possible embodiment, in a slot, symbol indexes of the first reference signal are 2 and 4, 3 and 5, 8 and 10, or 9 and 11, where a symbol index starts from 0.

In the solution provided in the present disclosure, in order to make full use of one symbol between two symbols of a reference signal, a time interlace method can be used, that is, there is a first one of two symbols of the second reference signal between two symbols of the first reference signal, and so on. In this way, there is no empty symbol between two symbols of a reference signal, and thus energy can be saved and consumption can be reduced. A symbol index of a reference signal starts from 2, and the 0th symbol (with an index of 0), the first symbol (with an index of 1), the sixth symbol (with an index of 6) and the seventh symbol (with an index of 7) can be used for a terminal device to receive a PDCCH, and correspond to four beams of four reference signals, so as to achieve better coexistence of the reference signals and the PDCCH. The twelfth symbol (with an index of 12) and the thirteenth symbol (with an index of 13) can be used for the terminal device to send an uplink signal.

In a possible embodiment, in a slot, symbol indexes of the first reference signal are 4 and 8, 5 and 9, 6 and 10, or 7 and 11, where a symbol index starts from 0.

In the solution provided in the present disclosure, a symbol index of a reference signal starts from 4, and the 0th symbol (with an index of 0), the first symbol (with an index of 1), the second symbol (with an index of 2) and the third symbol (with an index of 3) can be used for a terminal device to receive a PDCCH, and correspond to four beams of four reference signals, so as to achieve better coexistence of the reference signals and the PDCCH. The twelfth symbol (with an index of 12) and the thirteenth symbol (with an index of 13) can be used for the terminal device to send an uplink signal.

In a possible embodiment, indexes of resource element (RE) occupied by the first reference signal in a resource block (RB) are 0, 4 and 8, where an RE index starts from 0.

In the solution provided in the present disclosure, the RE index starts from 0, which can reduce the complexity of a terminal device.

In a possible embodiment, indexes of REs occupied by the first reference signal in an RB are 0, 2, 4, 6, 8, and 10, where an RE index starts from 0.

In the solution provided in the present disclosure, frequency domain resources are doubled, thereby improving the precision.

In a possible embodiment, indexes of REs occupied by the first reference signal in an RB are 0, 1, 2, 3, 4, 5, 6, 7, 8, 9, 10, and 11, where an RE index starts from 0.

In the solution provided in the present disclosure, frequency domain resources are doubled, thereby improving the precision.

In a possible embodiment, the first reference signal is a physical broadcast channel demodulation reference signal (PBCH DMRS), and the second reference signal is a secondary synchronization signal (SSS).

In the solutions provided in the present disclosure, since the PBCH DMRS can support a terminal device to perform fine synchronization and RRM measurement, and the SSS can support a terminal device to perform coarse synchronization and RRM measurement, the PBCH DMRS and the SSS can be used as reference signals on a non-anchor carrier or cell.

In a possible embodiment, the M=2, and the N=3.

In the solutions provided in the present disclosure, a reference signal beam is two symbols of a reference signal separated by three symbols. Separation by three symbol may facilitate frequency tracking. When frequency offset estimation is performed on the two symbols of the reference signal, there is a certain symbol interval in the reference signal, in this way, noises of channels corresponding to the two symbols of the reference signal are irrelevant and may be cancelled out when a self-correlation algorithm is performed.

In a possible embodiment, in a slot, symbol indexes of the first reference signal are 4 and 8, 5 and 9, 6 and 10, or 7 and 13, where a symbol index starts from 0.

In the solution provided in the present disclosure, a time interlace method can be used, that is, an interval between two symbols of a reference signal corresponds to the first one of two symbols of another reference signal, and so on. In this way, there is no empty symbol between two symbols of a reference signal, and three symbols between two symbols of a reference signal can be fully used. A symbol index of A reference signal starts from 4, and the 0th symbol (with an index of 0), the first symbol (with an index of 1), the second symbol (with an index of 2), and the third symbol (with an index of 3) can be used for the terminal device to receive the PDCCH. The twelfth symbol (with an index of 12) and the thirteenth symbol (with an index of 13) can be used for the terminal device to send an uplink signal.

In a possible embodiment, indexes of REs occupied by the first reference signal in an RB are 1, 5 and 10, where an RE index starts from 0.

In the solution provided in the present disclosure, the RE index starts from 0, which can reduce the complexity of the terminal device.

In a possible embodiment, indexes of REs occupied by the first reference signal in an RB are 1, 3, 5, 7, 10, and 12, where an RE index starts from 0.

In the solution provided in the present disclosure, frequency domain resources are doubled, thereby improving the precision.

In a possible embodiment, indexes of REs occupied by the first reference signal in an RB are 0, 1, 2, 3, 4, 5, 6, 7, 8, 9, 10, and 11, where an RE index starts from 0.

In the solution provided in the present disclosure, frequency domain resources are doubled, so that the precision can be further improved.

In a possible embodiment, the first reference signal is a tracking reference signal (TRS).

In the solutions provided in the present disclosure, since the TRS can support the terminal device to perform synchronization and RRM measurement (in some cases), the TRS can be used as a reference signal on a non-anchor carrier or cell.

In a possible embodiment, M=1, and N=0.

In a possible embodiment, in a slot, symbol indexes of the first reference signal are 6, 7, 8, 9, 10, 11, 12, and 13, where the symbol index starts from 0.

In the solution provided in the present disclosure, the symbol index of a reference signal starts from 6, and the 0th symbol (with an index of 0), the first symbol (with an index of 1), the second symbol (with an index of 2), the third symbol (with an index of 3), the 4th symbol (with an index of 4) and the 5th symbol (with an index of 5) can be used for a terminal device to receive a PDCCH.

In a possible embodiment, in a slot, symbol indexes of the first reference signal are 4, 5, 6, 7, 8, 9, 10, and 11, where a symbol index starts from 0.

In the solution provided in the present disclosure, a symbol index of a reference signal starts from 4, and the 0th symbol (with an index of 0), the first symbol (with an index of 1), the second symbol (with an index of 2), and the third symbol (with an index of 3) may be used for a terminal device to receive a PDCCH. the twelfth symbol (with an index of 12) and the thirteenth symbol (with an index of 13) can be used for the terminal device to send an uplink signal.

In a possible embodiment, M=2, and N=0.

In the solution provided in the present disclosure, the number of reference signals on one beam is increased, for example, the number of reference signals on one beam is increased to 2, which can improve the synchronization precision and the RRM measurement precision.

In a possible embodiment, in a slot, symbol indexes of the first reference signal are 4 and 5, 6 and 7, 8 and 9, or 10 and 11, where a symbol index starts from 0.

In the solution provided in the present disclosure, a symbol index of a reference signal starts from 4, and the 0th symbol (with an index of 0), the first symbol (with an index of 1), the second symbol (with an index of 2) and the third symbol (with an index of 3) may be used for a terminal device to receive a PDCCH. The twelfth symbol (with an index of 12) and the thirteenth symbol (with an index of 13) can be used for the terminal device to send an uplink signal.

In a possible embodiment, the first reference signal is an SSS.

In the solution provided in the present disclosure, since the SSS can support the user equipment (UE) to perform synchronization and RRM measurement, the SSS can be used as a reference signal on a non-anchor carrier or cell. Although the SSS can only support coarse synchronization (an autocorrelation algorithm is unable to be performed with only one symbol, and only a cross-correlation algorithm can be performed) under a general algorithm, the cross-correlation algorithm can also support fine synchronization by means of a method such as increasing a bandwidth (a sequence length).

In a possible embodiment, the first reference signal occupies 20 RBs.

In the solution provided in the present disclosure, a reference signal occupies 20 RBs, which can improve synchronization precision and RRM measurement precision.

In a second aspect, the present disclosure provides a communication method. The method may be applied to a network device, and may also be applied to a module (for example, a chip) in the network device. The following description is given by being applied to a network device as an example. The method includes the following. A first reference signal is sent, where the first reference signal occupies M symbols, the M symbols are spaced apart by N symbols, M is an integer greater than 0, and N is an integer greater than or equal to 0.

In the solution provided in the present disclosure, a non-anchor carrier or cell supports paging, random access, RRM measurement, etc., and needs to carry a periodic reference signal, so as to support synchronization (time/frequency tracking) and mobility measurement (such as RRM measurement) of a terminal device. In embodiments of the present disclosure, a reference signal is simplified, so that the reference signal has a relatively short duration and a relatively fewer times of transition (transition between transmission and sleep), that is, the simplified reference signal can be concentrated in time as much as possible during beam sweeping, thereby saving energy and reducing consumption.

It should be understood that an execution subject of the second aspect is a network device. Specific contents of the second aspect correspond to contents of the first aspect. For corresponding features and achieved beneficial effects of the second aspect, reference may be made to the description of the first aspect. To avoid repetition, detailed description is appropriately omitted herein.

In a possible embodiment, M=2, and N=1.

In a possible embodiment, in a slot, symbol indexes of the first reference signal are 2 and 4, 5 and 7, 8 and 10, or 11 and 13, wherein a symbol index starts from 0.

In a possible embodiment, in a slot, symbol indexes of the first reference signal are 0 and 2, or 3 and 5, or 6 and 8, or 9 and 11, wherein a symbol index starts from 0.

In a possible embodiment, there is a second reference signal between two symbols of the first reference signal.

In a possible embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0.

In a possible embodiment, in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

In a possible embodiment, in a slot, symbol indexes of the first reference signal are 3 and 5, 6 and 8, or 9 and 11, wherein a symbol index starts from 0.

In a possible embodiment, in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

In a possible embodiment, in a slot, symbol indexes of the first reference signal are 2 and 4, 3 and 5, 8 and 10, or 9 and 11, wherein a symbol index starts from 0.

In a possible embodiment, in a slot, symbol indexes of the first reference signal are 4 and 8, 5 and 9, 6 and 10, or 7 and 11, wherein a symbol index starts from 0.

In a possible embodiment, indexes of resource elements (REs) occupied by the first reference signal in a resource block (RB) are 0, 4, and 8, wherein an RE index starts from 0.

In a possible embodiment, indexes of REs occupied by the first reference signal in an RB is 0, 2, 4, 6, 8, and 10, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a physical broadcast channel demodulation reference signal (PBCH DMRS), and the second reference signal is a secondary synchronization signal (SSS).

In a possible embodiment, M=2, and N=3.

In a possible embodiment, in a slot, symbol indexes of the first reference signal are 4 and 8, 5 and 9, 6 and 10, or 7 and 13, wherein a symbol index starts from 0.

In a possible embodiment, indexes of REs occupied by the first reference signal in an RB are 1, 5 and 10, wherein an RE index starts from 0.

In a possible embodiment, indexes of REs occupied by the first reference signal in an RB is 1, 3, 5, 7, 10 and 12, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a tracking reference signal (TRS).

In a possible embodiment, M=1, and N=0.

In a possible embodiment, in a slot, symbol indexes of the first reference signal are 6,

7, 8, 9, 10, 11, 12, 13, wherein a symbol index starts from 0.

In a possible embodiment, in a slot, symbol indexes of the first reference signal are 4, 5, 6, 7, 8, 9, 10, 11, wherein a symbol index starts from 0.

In a possible embodiment, M=2, and N=0.

In a possible embodiment, in a slot, symbol indexes of the first reference signal are 4 and 5, 6 and 7, 8 and 9, or 10 and 11, wherein a symbol index starts from 0.

In a possible embodiment, the first reference signal is a secondary synchronization signal (SSS).

In a possible embodiment, the first reference signal occupies 20 resource blocks (RBs).

In a third aspect, the present disclosure provides a communication device, which can be applied to a terminal device.

For beneficial effects, reference may be made to the description of the first aspect, and details are not repeatedly described herein. The communication device has functions to achieve actions in the method embodiments of the first aspect. The functions may be implemented by hardware or by hardware executing corresponding software, and the hardware or software includes one or more modules corresponding to the above functions.

In a possible embodiment, the communication device includes a receiving unit. The receiving unit is configured to receive a first reference signal, wherein the first reference signal occupies M symbols, the M symbols are spaced apart by N symbols, M is an integer greater than 0, and N is an integer greater than or equal to 0.

In a possible embodiment, M=2, and N=1.

In a possible embodiment, in a slot, symbol indexes of the first reference signal are 2 and 4, 5 and 7, 8 and 10, or 11 and 13, wherein a symbol index starts from 0.

In a possible embodiment, in a slot, symbol indexes of the first reference signal are 0 and 2, or 3 and 5, or 6 and 8, or 9 and 11, wherein a symbol index starts from 0.

In a possible embodiment, there is a second reference signal between two symbols of the first reference signal.

In a possible embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0.

In a possible embodiment, in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

In a possible embodiment, in a slot, symbol indexes of the first reference signal are 3 and 5, 6 and 8, or 9 and 11, wherein a symbol index starts from 0.

In a possible embodiment, in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

In a possible embodiment, in a slot, symbol indexes of the first reference signal are 2 and 4, 3 and 5, 8 and 10, or 9 and 11, wherein a symbol index starts from 0.

In a possible embodiment, in a slot, symbol indexes of the first reference signal are 4 and 8, 5 and 9, 6 and 10, or 7 and 11, wherein a symbol index starts from 0.

In a possible embodiment, indexes of resource elements (REs) occupied by the first reference signal in a resource block (RB) are 0, 4, and 8, wherein an RE index starts from 0.

In a possible embodiment, indexes of REs occupied by the first reference signal in an RB is 0, 2, 4, 6, 8, and 10, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a physical broadcast channel demodulation reference signal (PBCH DMRS), and the second reference signal is a secondary synchronization signal (SSS).

In a possible embodiment, M=2, and N=3.

In a possible embodiment, in a slot, symbol indexes of the first reference signal are 4 and 8, 5 and 9, 6 and 10, or 7 and 13, wherein a symbol index starts from 0.

In a possible embodiment, indexes of REs occupied by the first reference signal in an RB are 1, 5 and 10, wherein an RE index starts from 0.

In a possible embodiment, indexes of REs occupied by the first reference signal in an RB is 1, 3, 5, 7, 10 and 12, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a tracking reference signal (TRS).

In a possible embodiment, M=1, and N=0.

In a possible embodiment, in a slot, symbol indexes of the first reference signal are 6, 7, 8, 9, 10, 11, 12, 13, wherein a symbol index starts from 0.

In a possible embodiment, in a slot, symbol indexes of the first reference signal are 4, 5, 6, 7, 8, 9, 10, 11, wherein a symbol index starts from 0.

In a possible embodiment, M=2, and N=0.

In a possible embodiment, in a slot, symbol indexes of the first reference signal are 4 and 5, 6 and 7, 8 and 9, or 10 and 11, wherein a symbol index starts from 0.

In a possible embodiment, the first reference signal is a secondary synchronization signal (SSS).

In a possible embodiment, the first reference signal occupies 20 resource blocks (RBs).

In a fourth aspect, the present disclosure provides a communication device, which may be applied to a network device.

For beneficial effects, reference may be made to the description of the second aspect, and details are not repeatedly described herein. The communication device has functions to achieve actions in the method embodiments of the second aspect. The functions may be implemented by hardware or by hardware executing corresponding software, and the hardware or software includes one or more modules corresponding to the above functions.

In a possible embodiment, the communication device includes a sending unit. The sending unit is configured to send a first reference signal, wherein the first reference signal occupies M symbols, the M symbols are spaced apart by N symbols, M is an integer greater than 0, and N is an integer greater than or equal to 0

In a possible embodiment, M=2, and N=1.

In a possible embodiment, in a slot, symbol indexes of the first reference signal are 2 and 4, 5 and 7, 8 and 10, or 11 and 13, wherein a symbol index starts from 0.

In a possible embodiment, in a slot, symbol indexes of the first reference signal are 0 and 2, or 3 and 5, or 6 and 8, or 9 and 11, wherein a symbol index starts from 0.

In a possible embodiment, there is a second reference signal between two symbols of the first reference signal.

In a possible embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0.

In a possible embodiment, in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

In a possible embodiment, in a slot, symbol indexes of the first reference signal are 3 and 5, 6 and 8, or 9 and 11, wherein a symbol index starts from 0.

In a possible embodiment, in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

In a possible embodiment, in a slot, symbol indexes of the first reference signal are 2 and 4, 3 and 5, 8 and 10, or 9 and 11, wherein a symbol index starts from 0.

In a possible embodiment, in a slot, symbol indexes of the first reference signal are 4 and 8, 5 and 9, 6 and 10, or 7 and 11, wherein a symbol index starts from 0.

In a possible embodiment, indexes of resource elements (REs) occupied by the first reference signal in a resource block (RB) are 0, 4, and 8, wherein an RE index starts from 0.

In a possible embodiment, indexes of REs occupied by the first reference signal in an RB is 0, 2, 4, 6, 8, and 10, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a physical broadcast channel demodulation reference signal (PBCH DMRS), and the second reference signal is a secondary synchronization signal (SSS).

In a possible embodiment, M=2, and N=3.

In a possible embodiment, in a slot, symbol indexes of the first reference signal are 4 and 8, 5 and 9, 6 and 10, or 7 and 13, wherein a symbol index starts from 0.

In a possible embodiment, indexes of REs occupied by the first reference signal in an RB are 1, 5 and 10, wherein an RE index starts from 0.

In a possible embodiment, indexes of REs occupied by the first reference signal in an RB is 1, 3, 5, 7, 10 and 12, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a tracking reference signal (TRS).

In a possible embodiment, M=1, and N=0.

In a possible embodiment, in a slot, symbol indexes of the first reference signal are 6, 7, 8, 9, 10, 11, 12, 13, wherein a symbol index starts from 0.

In a possible embodiment, in a slot, symbol indexes of the first reference signal are 4, 5, 6, 7, 8, 9, 10, 11, wherein a symbol index starts from 0.

In a possible embodiment, M=2, and N=0.

In a possible embodiment, in a slot, symbol indexes of the first reference signal are 4 and 5, 6 and 7, 8 and 9, or 10 and 11, wherein a symbol index starts from 0.

In a possible embodiment, the first reference signal is a secondary synchronization signal (SSS).

In a possible embodiment, the first reference signal occupies 20 resource blocks (RBs).

In a fifth aspect, a communication device is provided. The device may be a terminal device, or may be a module (for example, a chip) in the terminal device. The communication device includes a processor, a memory, an input interface, and an output interface. The input interface is configured to receive information from another communication device except the communication device. The output interface is configured to output information to another communication device except the communication device. The processor is configured to invoke a computer program stored in the memory to implement the communication method of any embodiment in the first aspect or in the second aspect.

In a sixth aspect, a communication device is provided. The device may be a network device, or may be a module (for example, a chip) in the network device. The communication device may include a processor, a memory, an input interface, and an output interface. The input interface is configured to receive information from another communication device except the communication device. The output interface is configured to output information to another communication device except the communication device. The processor is configured to invoke a computer program stored in the memory to implement the communication method of any embodiment in the first aspect or in the second aspect.

In a seventh aspect, the present disclosure provides a communication system. The communication system includes at least one terminal device and at least one network device. When the at least one terminal device and the at least one network device run in the communication system, the communication system is configured to execute any method in the first aspect or the second aspect.

In an eighth aspect, the present disclosure provides a computer-readable storage medium. The computer-readable storage medium stores a computer instruction. When a computer program or the computer instruction is running, the method in the first aspect and any possible embodiment of the first aspect or the method in the second aspect and any possible embodiment of the first aspect is caused to be executed.

In a ninth aspect, the present disclosure provides a computer program product including an executable instruction. When the computer program product runs on a UE, the method in the first aspect and any possible embodiment of the first aspect or the method in the second aspect and any possible embodiment of the second aspect is caused to be executed.

In a tenth aspect, the present disclosure provides a chip system. The chip system includes a processor, and can further include a memory for implementing the method in the first aspect and any possible embodiment of the first aspect or the method in the second aspect and any possible embodiment of the second aspect. The chip system may consist of a chip, and may also consist of a chip and other discrete components.

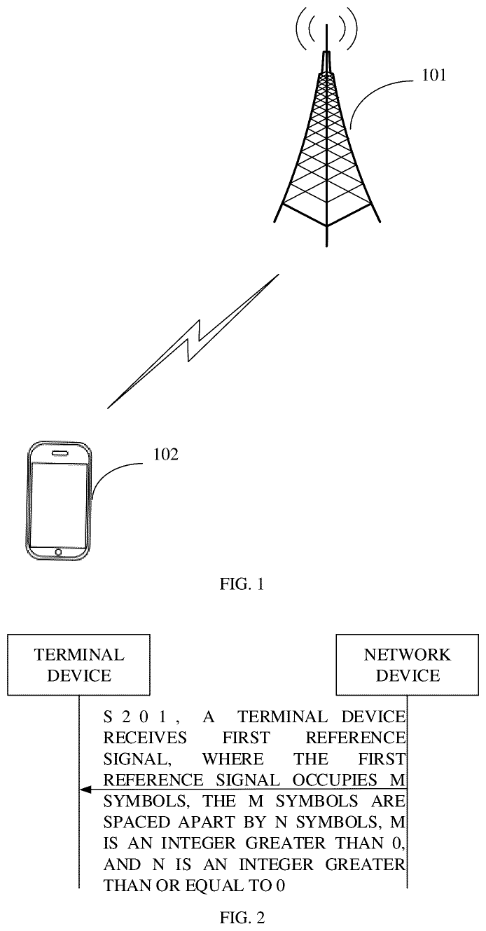

FIG. 1 is a schematic structural diagram of a network architecture provided in an embodiment of the present disclosure. As illustrated in FIG. 1, the network architecture may include a network device 101 and a terminal device 102. The terminal device 102 may be wirelessly connected to the network device 101, and may access the network through the network device 101. The terminal device 102 may be fixed or mobile.

The network device 101 may be an entity for transmitting or receiving signals, and may be a device configured to communicate with a terminal device. The network device may be a base transceiver station (BTS) in a global system for mobile communications (GSM) system or a code division multiple access (CDMA) system, a NodeB (NB) in a wideband code division multiple access (WCDMA) system, an evolved NodeB (eNB or eNodeB) in an LTE system, or a radio controller in a scenario of a cloud radio access network. Alternatively, the network device may be a relay station, an access point (AP), a vehicle-mounted device, a wearable device, a network device in a 5G network, or a network device in a future evolved public land mobile network (PLMN) network, or the like, which are not limited in embodiments of the present disclosure. The network device may be a device in a wireless network, for example, a radio access network (RAN) node for connecting a terminal to the wireless network. At present, the RAN node may be, for example, a base station, a next generation NodeB (gNB), a transmission reception point (TRP), an evolved Node B (eNB), a home base station, a baseband unit (BBU), or an AP in a WiFi system. In a network architecture, a network device may include a centralized unit (CU) node, or a distributed unit (DU) node, or a RAN device including a CU node and a DU node.

The terminal device 102, which is a user-side entity for receiving or transmitting signals, such as a user equipment (UE), an access terminal, a subscriber unit, a subscriber station, a mobile station, a mobile platform, a remote station, a remote terminal, a mobile device, a user terminal, a terminal, a wireless communication device, a user agent, a user apparatus, etc. The terminal device may also be a mobile phone, a cellular phone, a cordless phone, a session initiation protocol (SIP) phone, a tablet computer (Pad), a computer with a wireless transmit/receive function, or a virtual reality (VR) terminal device, an augmented reality (AR) terminal device, a wireless terminal in industrial control, a wireless local loop (WLL) station, a personal digital assistant (PDA), a handheld device having wireless communication functions, a computing device, or other processing device connected to a wireless modem, a vehicle mounted device, a wireless terminal in a self-driving, a wireless terminal in remote medical, a wireless terminal in smart grid, a wireless terminal in transport safety, a wireless terminal in a smart city, a wireless terminal in a smart home, a wearable device (e. g., a smart watch, a smart bracelet, a pedometer, etc.), a terminal device in a 5G network or a future evolved (PLMN), which are not limited in embodiments of the present disclosure. The terminal device can be deployed on land, including indoor or outdoor, handheld, wearable, or vehicle-mounted; on water (e.g., a ship); and also can be deployed in the air (e.g., an aircraft, a balloon, and a satellite).

As an example but not limitation, in embodiments of the disclosure, the terminal device may also be a wearable device. The wearable device can also be called a wearable smart device, which is a collective name of wearable devices intelligently designed and developed by applying a wearable technology to daily wear, such as glasses, gloves, watches, clothing, shoes, etc. The wearable device is a portable device that can be worn directly on the body or integrated into clothing or accessories of a user. The wearable device not only is a hardware device but also can realize powerful functions through software support, data interaction, and cloud interaction. Broadly speaking, the wearable smart device includes a device that has full functions and a large size and can realize all or part of functions without relying on a smart phone, e.g., a smart watch, smart glasses, or the like, and includes a device that only focuses on a certain application function and needs to be used with other devices such as a smart phone, e.g., all kinds of smart bracelets and smart jewelry for physical symbol monitoring or the like. In addition, in embodiments of the present disclosure, the terminal device can also be a terminal in an Internet of things (IoT) system, where IoT is an important component of future information technology development. A main technical feature of IoT is connecting things to networks by using communications technologies, to implement an intelligent network for interconnection between persons and machines, and between things. In embodiments of the present disclosure, the IoT technology can implement massive connections, in-depth coverage, and terminal power saving by using, for example, a narrow band (NB) technology. In addition, in embodiments of this application, the terminal device may further include a sensor such as an intelligent printer, a train detector, or a gas station. Main functions of the terminal device include collecting data (for some terminal devices), receiving control information and downlink data from a network device, sending an electromagnetic wave, and transmitting uplink data to the network device.

The technical solutions of embodiments of the present disclosure may be applied to various communication systems, for example, a GSM system, a CDMA system, a WCDMA system, and a general packet radio service (GPRS) system, a long term evolution (LTE) system, an LTE frequency division duplex (FDD) system, an LTE time division duplex (TDD) system, a universal mobile telecommunications system (UMTS) system, an enhanced data rate for GSM evolution (EDGE) system, and a worldwide interoperability for microwave access (WiMAX) system. The technical solutions of the embodiments of the present disclosure may also be applied to other communication systems, for example, a PLMN system, an LTE advanced (LTE-A) system, the fifth generation mobile communication (5G) system, a new radio (NR) system, a machine to machine (M2M) system, or other future evolved communication systems, which is not limited in embodiments of the present disclosure.

In embodiments of the disclosure, the terminal or the network device includes a hardware layer, an operating system layer running above the hardware layer, and an application layer running above the operating system layer. The hardware layer includes a central processing unit (CPU), a memory management unit (MMU), a memory (also called main memory), or other hardware. The operating system may be any one or various computer operating systems that achieve service processing through processes, e.g., a Linux® operating system, a Unix® operating system, an Android® operating system, an iOS® operating system, a Windows® operating system, or the like. The application layer includes a browser, an address book, a word processing software, an instant messaging software, or other applications. Furthermore, a specific structure of the execution body of the method provided in embodiments of the disclosure is not particularly limited herein, as long as the execution body can perform communication according to the method provided in embodiments of the disclosure by running a program containing codes for realizing the method provided in embodiments of the disclosure. For example, the execution body of the method provided in embodiments of the disclosure may be a terminal or a network device or a function module that is in the terminal or the network device and can invoke and execute the program.

It can be noted that the number and types of terminal devices included in the network architecture as illustrated in FIG. 1 are merely examples, and the embodiments of the present disclosure are not limited thereto. For example, more or less terminal devices communicating with the network device may be included, which are not described one by one in the accompanying drawings for brevity of description. In addition, in the network architecture as illustrated in FIG. 1, although a network device and a terminal are illustrated, the application scenario may not be limited to including a network device and a terminal, for example, may also include a core network node or a device for bearing a virtualized network function, which are obvious to a person skilled in the art, and are not further described herein.

With reference to the foregoing network architecture, the following describes a communication method provided in an embodiment of the present disclosure. FIG. 2 is a schematic flowchart of a communication method provided in an embodiment of the present disclosure. In the present disclosure, functions performed by a terminal device may also be performed by a module (for example, a chip) in the terminal device, and functions performed by a network device may also be performed by a module (for example, a chip) in the network device. As illustrated in FIG. 2, the method may include the following.

At S201, the terminal device receives a first reference signal, where the first reference signal occupies M symbols, the M symbols are spaced apart by N symbols, M is an integer greater than 0, and N is an integer greater than or equal to 0.

It may be understood that, in the embodiment of the present disclosure, a slot includes multiple symbols or multiple columns of symbols. The first reference signal occupies M symbols, or the first reference signal occupies M columns of symbols. For example, a slot includes 14 symbols, and symbol indexes of the 14 symbols are 0, 1, . . . , and 13 respectively. For example, a slot includes 12 symbols, wand symbol indexes of the 12 symbols are 0, 1, . . . , and 11 respectively.

In embodiments of the present disclosure, M is a positive integer less than 3.

It can be understood that, in embodiments of the present disclosure, the M symbols are spaced apart by N symbols, which indicates that the M symbols are separated by N symbols, or N symbols exist between the M symbols. For example, when M=2, the M symbols are spaced apart by N symbols, which indicates that the two symbols are separated by N symbols, or that N symbols exist between the two symbols. When M=1, N can only be 0, and the M symbols are spaced apart by N symbols, which indicates that the 1 symbol is separated by 0 symbols (namely, not separated by a symbol), and that 0 symbols exist between the 1 symbol (namely, no symbol exists).

Generally, the first reference signal may be used for time-frequency synchronization. Specifically, the first reference signal may be a secondary synchronization signal (SSS), a physical broadcast channel demodulation reference signal (PBCH DMRS), and a tracking reference signal (TRS).

In one embodiment, the first reference signal occupies M symbols, and the M symbols are spaced apart by N symbols. When the first reference signal is an SSS, the first reference signal occupies M symbols, which indicates that the SSS occupies one symbol; and when the first reference signal is a PBCH DMRS, the first reference signal occupies M symbols, which indicates that the PBCH DMRS occupies two symbols. When the first reference signal is a TRS, the first reference signal occupies M symbols, which indicates that the TRS occupies two symbols (for a single slot). It can be noted that, one TRS may occupy four symbols, and occupies two symbols in each slot; and one TRS may also occupy two symbols, and occupies two symbols in each slot. It can be noted that, the TRS may also be regarded as a single-port channel state information reference signal (CSI-RS).

In another embodiment, in a configuration of the first reference signal, the first reference signal occupies M symbols, and the M symbols are spaced apart by N symbols. When the first reference signal is an SSS, in a configuration of the first reference signal, the first reference signal occupies M symbols, which indicates that, in an SSS configuration, the SSS occupies one symbol. When the first reference signal is a PBCH DMRS, in a configuration of the first reference signal, the first reference signal occupies M symbols, which indicates that, in a PBCH DMRS configuration, the PBCH DMRS occupies two symbols. When the first reference signal is a TRS, in a configuration of the first reference signal, the first reference signal occupies M symbols, which indicates that, in a TRS configuration, the TRS occupies two symbols (for a single slot). It can be noted that, in the TRS configuration, the TRS may occupy four symbols, and occupies two symbols in each slot; and in the RS configuration, the TRS may also occupy two symbols, and occupies two symbols in each slot. It can be noted that, the TRS may also be regarded as a single-port CSI-RS. It can be noted that a TRS configuration may be a configuration of a CSI-RS resource set.

In yet another embodiment, in a slot, the first reference signal occupies M symbols, the M symbols are spaced apart by N symbols. When the first reference signal is an SSS, in a slot, the first reference signal occupies M symbols, which indicates that in a slot, the SSS occupies one symbol. When the first reference signal is a PBCH DMRS, in a slot, the first reference signal occupies M symbols, which indicates that in a slot, the PBCH DMRS occupies two symbols. When the first reference signal is a TRS, in a slot, the first reference signal occupies M symbols, which indicates that in a slot, the TRS occupies two symbols. It can be noted that, the TRS occupies two symbols in a slot. It can be noted that the TRS may also be regarded as a single-port CSI-RS.

In yet another embodiment, in a slot, in a configuration of the first reference signal, the first reference signal occupies M symbols, and M symbols are spaced apart by N symbols. When the first reference signal is an SSS, in a slot and in a configuration of the first reference signal, the first reference signal occupies M symbols, which indicates that in a slot and in an SSS configuration, the SSS occupies one symbol. When the first reference signal is a PBCH DMRS, in a slot and in a configuration of the first reference signal, the first reference signal occupies M symbols, which indicates that in a slot and in a PBCH DMRS configuration, the PBCH DMRS occupies two symbols. When the first reference signal is a TRS, in one slot and in a configuration of the first reference signal, the first reference signal occupies M symbols, which indicates that, in one slot and in a TRS configuration, the TRS occupies two symbols. It can be noted that, in a configuration of the first reference signal, the TRS occupies two symbols in a slot. It can be noted that the TRS may also be considered as a single-port CSI-RS. It can be noted that the TRS configuration may be a configuration of one CSI-RS resource set.

For power saving, a simplified periodic reference signal needs to have a shorter duration and fewer times of transition (transition between transmission and sleep) as far as possible, that is, the simplified periodic reference signal should be concentrated in time as far as possible during beam sweeping. It can be noted that, on a non-anchor carrier or cell, although a periodic reference signal may be simplified, a beam scanning still needs to be performed, and a certain number of beams are needed to meet coverage requirements. A specific manner may be any one of the following:

In a first manner, the first reference signal occupies two symbols, and the two symbols are spaced apart by one symbol, and a reference signal beam is a reference signal of two symbols separated by one symbol. An interval of one symbol may facilitate frequency tracking. When frequency offset estimation is performed on the two symbols of the reference signal, there is a certain symbol interval in the reference signal. In this way, noises of channels corresponding to the two symbols of the reference signal are irrelevant and may be cancelled out when a self-correlation algorithm is performed.

1. One slot corresponds to four beams, and the network device can send a first reference signal beam in a slot. In a frequency range 1 (FR1), a maximum of eight beams are supported, and therefore eight beams can be sent in two consecutive slots; and if an SS/PBCH BLOCK is used, at least four consecutive slots are required to send eight beams. In a frequency range 2 (FR2), a total of 64 beams are supported, and therefore 64 beams can be sent in 16 consecutive slots; and if the SS/PBCH BLOCK is used, at least 32 consecutive slots are required to send 64 beams. By simplifying the first reference signal, eight beams can be sent in two consecutive slots, thereby saving energy and reducing consumption.

For example, a slot includes 14 symbols with symbol indexes being respectively 0, 1, 2, 3, 4, 5, 6, 7, 8, 9, 10, 11, 12, and 13, that is, in a slot, a symbol index starts from 0. A symbol index of a symbol occupied by a first reference signal (hereinafter “a symbol index of the first reference signal” for short) is specifically described as follows.

In one embodiment, in a slot, symbol index of the first reference signal are 2 and 4, 5 and 7, 8 and 10, or 11 and 13. In this way, four first reference signals, that is, four beams, may be placed in one slot. The symbol index of the first reference signal starts from 2, and the 0th symbol (with an index of 0) and the first symbol (with an index of 1) can be used for the terminal device to receive the PDCCH.

In another embodiment, in a slot, the symbol indexes of the first reference signal are 0 and 2, 3 and 5, 6 and 8, or 9 and 11. In this way, four first reference signals, that is, four beams, can be placed in one slot, and the twelfth symbol (with an index of 12) and the thirteenth symbol (with an index of 13) can be used for a terminal device to send an uplink signal.

2. A second reference signal is between two symbols of the first reference signal. To utilize a symbol between two symbols of the reference signal, another reference signal of one symbol may be transmitted on the symbol. In this way, there is no empty between two symbols of the reference signal.

In one embodiment, in a slot, the symbol indexes of the first reference signal are 2 and 4, and the symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12. In this way, four first reference signals, that is, four beams, may be placed in one slot. A symbol index of a reference signal starts from 2, and the 0th symbol (with an index of 0) and the first symbol (with an index of 1) may be used for a terminal device to receive a PDCCH.

In another embodiment, in a slot, the symbol indexes of the first reference signal are 0 and 2, and the symbol index of the second reference signal is 1; or the symbol indexes of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10. In this way, four first reference signals, that is, four beams, can be placed in one slot, and the twelfth symbol (with an index of 12) and the thirteenth symbol (with an index of 13) can be used for a terminal device to send an uplink signal.

3. One slot corresponds to three beams, and in a slot, the symbol indexes of the first reference signal are 3 and 5, 6 and 8, or 9 and 11. In this way, three first reference signals, that is, three beams, can be placed in one slot. A symbol index of a reference signal starts from 3, the 0th symbol (with an index of 0), the first symbol (with an index of 1), and the second symbol (with an index of 2) can be used for a terminal device to receive a PDCCH, and correspond to three beams of the three reference signals, so as to achieve better coexistence of the reference signals and the PDCCH. The twelfth symbol (with an index of 12) and the thirteenth symbol (with an index of 13) can be used for the terminal device to send an uplink signal.

4. A second reference signal is between two symbols of the first reference signal.

One slot corresponds to three beams, and in the FR1, a maximum of eight beams are supported in total, and therefore eight beams can be sent in three consecutive slots; and if an SS/PBCH BLOCK is used, at least four consecutive slots are required to send eight beams. In the FR2, a total of 64 beams are supported, and therefore, 64 beams can be sent in 24 consecutive slots; and if an SS/PBCH BLOCK is used, at least 32 consecutive slots are required to transmit 64 beams. By simplifying reference signals, eight beams can be sent in three consecutive slots, thereby saving energy and reducing consumption.

In one embodiment, in a slot, the symbol indexes of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10. In this way, three first reference signals, that is, three beams, can be placed in one slot. A symbol index of a reference signal starts from 3, the 0th symbol (with an index of 0), the first symbol (with an index of 1), and a second symbol (with an index of 2) can be used for a terminal device to receive a PDCCH, and correspond to three beams of the three reference signals, so as to achieve better coexistence of the reference signals and the PDCCH. The twelfth symbol (with an index of 12) and the thirteenth symbol (with an index of 13) can be used for the terminal device to send an uplink signal.

5. A time-interlaced first reference signal. In order to make full use of a symbol between two symbols of a reference signal, a time interlace method may be used, that is, an interval between two symbols of the first reference signal corresponds to the first one of two symbols of the second reference signal, and so on. In this way, there is no empty symbol between two symbols of a reference signal, thereby saving energy and reducing consumption.

In one embodiment, in a slot, the symbol indexes of the first reference signal are 2 and 4, 3 and 5, 8 and 10, or 9 and 11. A symbol indexes of a reference signals starts from 2, and the 0th symbol (with an index of 0), the first symbol (with an index of 1), the sixth symbol (with an index of 6), and the seventh symbol (with an index of 7) can be used for the terminal device to receive the PDCCH, and correspond to four beams of four reference signals, so as to achieve better coexistence of the reference signals and the PDCCH. The twelfth symbol (with an index of 12) and the thirteenth symbol (with an index of 13) can be used for the terminal device to send an uplink signal.

In another embodiment, in a slot, the symbol indexes of the first reference signal are 4 and 8, 5 and 9, 6 and 10, or 7 and 11. A symbol index of the reference signal starts from 4, and the 0th symbol (with an index of 0), the first symbol (with an index of 1), the second symbol (with an index of 2), and the third symbol (with an index of 3) can be used for the terminal device to receive the PDCCH, and correspond to four beams of the four reference signals, so as to achieve better coexistence of the reference signals and the PDCCH. The twelfth symbol (with an index of 12) and the thirteenth symbol (with an index of 13) can be used for the terminal device to send an uplink signal.

Time-domain resources of the first reference signal:

In one embodiment, indexes of REs occupied by the first reference signal in an RB are 0, 4, and 8, so as to reduce complexity of the terminal device.

In another embodiment, indexes of Res occupied by the first reference signal in an RB are 0, 2, 4, 6, 8, and 10, so as to double the frequency domain resources, and improve the precision.

In yet another embodiment, indexes of REs occupied by the first reference signal in an RB ARE 0, 1, 2, 3, 4, 5, 6, 7, 8, 9, 10, and 11, so as to increase the frequency domain resources twice, and further improve the precision.

In a specific embodiment, the first reference signal in the first manner may be a PBCH DMRS, and the second reference signal may be an SSS. Since the PBCH DMRS can support the terminal device to perform fine synchronization and RRM measurement and the SSS can support the terminal device to perform coarse synchronization and RRM measurement, the PBCH DMRS and the SSS can serve as reference signals on a non-anchor carrier or cell. In order to enable the PBCH DMRS to be concentrated in time as much as possible during beam sweeping, the number of PBCH DMRS beams in one slot can be increased.

In a second manner, the first reference signal occupies two symbols, and the two symbols are spaced apart by three symbols. One reference signal beam is a reference signal of two symbols separated by three symbols. Separation by three symbols may facilitate frequency tracking. When frequency offset estimation is performed on two symbols of the reference signal, there is a certain symbol interval in the reference signals. In this way, noises of channels corresponding to the two symbols of the reference signal are not correlated and can be cancelled when a self-correlation algorithm is performed.

One slot corresponds to four beams, and the network device may send the first reference signal beam in a slot. In the FR1, a maximum of eight beams are supported in total, and therefore eight beams can be sent in two consecutive slots; and if an SS/PBCH BLOCK is used, at least four consecutive slots are required to send eight beams. In the FR2, a total of 64 beams are supported, and therefore 64 beams can be sent in 16 consecutive slots; and if the SS/PBCH BLOCK is used, at least 32 consecutive slots are required to send 64 beams. By simplifying the first reference signal, eight beams can be sent in two consecutive slots, thereby saving energy and reducing consumption.

In a slot, the symbol indexes of the first reference signal are 4 and 8, 5 and 9, 6 and 10, or 7 and 13. A time interlace method is used, that is, in interval between two symbols of a reference signal corresponds to the first one of two symbols of another reference signal, and so on. In this way, there is no empty symbol between two symbols of one reference signal, and three symbols between two symbols of one reference signal can be fully used. A symbol index of a reference signal starts from 4, and the 0th symbol (with an index of 0), the first symbol (with an index of 1), the second symbol (with an index of 2), and the third symbol (with an index of 3) can be used for the terminal device to receive the PDCCH. The twelfth symbol (with an index of 12) and the thirteenth symbol (with an index of 13) can be used for the terminal device to send an uplink signal.

Time-domain resources of the first reference signal:

In one embodiment, indexes of REs occupied by the first reference signal in an RB are 1, 5, and 10, so as to reduce complexity of the terminal device.

In another embodiment, indexes of Res occupied by the first reference signal in an RB are 1, 3, 5, 7, 10, and 12, so as to double the frequency domain resources, and improve the precision.

In yet another embodiment, indexes of REs occupied by the first reference signal in an RB are 0, 1, 2, 3, 4, 5, 6, 7, 8, 9, 10, and 11, so as to increase the frequency domain resources twice, and further improve the precision.

In a specific embodiment, the first reference signal in the second manner may be a TRS. The TRS can support the terminal device to perform synchronization and RRM measurement (in some cases), therefore the TRS may serve as a reference signal on a non-anchor carrier or cell. In order to enable the TRS to be concentrated in time as much as possible during beam sweeping, the number of TRS beams in one slot can be increased.

In the third manner, the first reference signal occupies one or two symbols.

1. The first reference signal occupies one symbol.

One slot corresponds to eight beams, and in the FR1, a maximum of eight beams are supported in total, and therefore eight beams can be sent in one slot; and if an SS/PBCH BLOCK is used, at least four consecutive slots are required to send eight beams. In the FR2, a total of 64 beams are supported, and therefore 64 beams can be sent in eight consecutive slots; and if the SS/PBCH BLOCK is used, at least 32 consecutive slots are required to send 64 beams. By simplifying the first reference signal, eight beams can be sent in one slot, thereby saving energy and reducing consumption.

In one embodiment, in a slot, the symbol indexes of the first reference signal are 6, 7, 8, 9, 10, 11, 12, and 13. A symbol index of a reference signal starts from 6, and the 0th symbol (with an index of 0), the first symbol (with an index of 1), the second symbol (with an index of 2), the third symbol (with an index of 3), the fourth symbol (with an index of 4), and the fifth symbol (with an index of 5) can be used for the terminal device to receive the PDCCH.

In another embodiment, in a slot, the symbol indexes of the first reference signal are 4, 5, 6, 7, 8, 9, 10, and 11. A symbol index of a reference signal starts from 4, and the 0th symbol (with an index of 0), the first symbol (with an index of 1), the second symbol (with an index of 2), and the third symbol (with an index of 3) can be used for the terminal device to receive the PDCCH. The twelfth symbol (with an index of 12) and the thirteenth symbol (with an index of 13) can be used for the terminal device to send an uplink signal.

2. The first reference signal occupies two symbols, and the number of reference signals on one beam is increased, for example, the number of the reference signals on one beam is increased to 2, so that the synchronization precision and the RRM measurement precision can be improved.

One slot corresponds to four beams, and the network device can transmit the first reference signal beam in a slot. In the FR1, a maximum of eight beams are supported in total, and therefore eight beams can be sent in two consecutive slots; and if an SS/PBCH BLOCK is used, at least four consecutive slots are required to send eight beams. In the FR2, a total of 64 beams are supported, and therefore 64 beams can be sent in 16 consecutive slots; and if the SS/PBCH BLOCK is used, at least 32 consecutive slots are required to send 64 beams. By simplifying the first reference signal, eight beams can be sent in two consecutive slots, thereby saving energy and reducing consumption.

In a slot, the symbol indexes of the first reference signal are 4 and 5, 6 and 7, 8 and 9, or 10 and 11. A symbol index of a reference signal starts from 4, and the 0th symbol (with an index of 0), the first symbol (with an index of 1), the second symbol (with an index of 2), and the third symbol (with an index of 3) can be used for the terminal device to receive the PDCCH. The twelfth symbol (with an index of 12) and the thirteenth symbol (with an index of 13) can be used for the terminal device to send an uplink signal.

Time domain resources of the first reference signal: the first reference signal occupies 20 RBs. The reference signal occupies 20 RBs, thereby improving the synchronization precision and the RRM measurement precision.

In a specific embodiment, the first reference signal in the third manner may be an SSS. The SSS can support synchronization and RRM measurement of the UE, the SSS may serve as a reference signal on a non-anchor carrier or cell. Although the SSS can only support coarse synchronization (an autocorrelation algorithm is unable to be performed with only one symbol, and only a cross-correlation algorithm can be performed) under a general algorithm, the cross-correlation algorithm can also support fine synchronization by means of a method such as increasing a bandwidth (a sequence length). In order to enable the SSS to be concentrated in time as much as possible during beam sweeping, the number of SSS beams in a slot can be increased.

In conclusion, the above manners can be predefined, and can also be sent by a network device to a terminal device via higher-layer signaling, where the higher-layer signaling can be RRC or DCI or other higher-layer signaling, and the types of the higher-layer signaling are not limited in embodiments of the present disclosure.

Correspondingly, the network device sends the first reference signal, and then the terminal device and the network device perform synchronization and RRM measurement according to the first reference signal.

It can be noted that, in embodiments of the present disclosure, for illustrative purpose, the terminal device and the network device communicate with each other by using a slot as a granularity, where a minimum constitution unit of the slot is a symbol. Certainly, the technical solutions of the embodiments of the present disclosure may also be applied to a scenario where the terminal device and the network device communicate with each other by using a time unit as a granularity, where a minimum constitution unit of the time unit is a time subunit. For example, the time unit may be a sub-frame, and the time sub-unit may be a slot, which is not limited in embodiments of the present disclosure.

The foregoing describes method embodiments provided in embodiments of the present disclosure. The following will describe virtual device embodiments involved in the embodiments of the present disclosure.

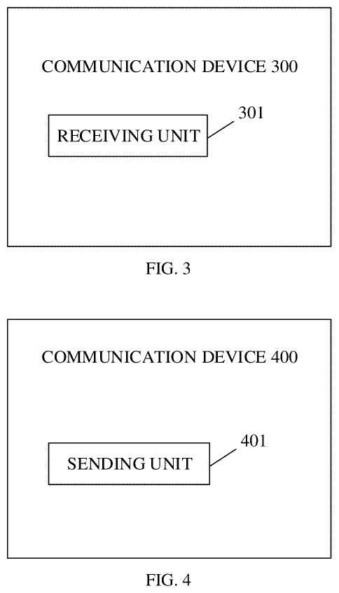

FIG. 3 is a schematic structural diagram of a communication device provided in an embodiment of the present disclosure. The device may be a terminal device or a module (for example, a chip) in the terminal device. As illustrated in FIG. 3, the communication device 300 at least includes a receiving unit 301.

The receiving unit 301 is configured to receive a first reference signal, where the first reference signal occupies M symbols, the M symbols are spaced apart by N symbols, M is an integer greater than 0, and N is an integer greater than or equal to 0.

In an embodiment, M=2, and N=1.

In an embodiment, in a slot, symbol indexes of the first reference signal are 2 and 4, 5 and 7, 8 and 10, or 11 and 13, wherein a symbol index starts from 0.

In an embodiment, in a slot, symbol indexes of the first reference signal are 0 and 2, or 3 and 5, or 6 and 8, or 9 and 11, wherein a symbol index starts from 0.

In an embodiment, there is a second reference signal between two symbols of the first reference signal.

In an embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0.

In an embodiment, in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

In an embodiment, in a slot, symbol indexes of the first reference signal are 3 and 5, 6 and 8, or 9 and 11, wherein a symbol index starts from 0.

In an embodiment, in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

In an embodiment, in a slot, symbol indexes of the first reference signal are 2 and 4, 3 and 5, 8 and 10, or 9 and 11, wherein a symbol index starts from 0.

In an embodiment, in a slot, symbol indexes of the first reference signal are 4 and 8, 5 and 9, 6 and 10, or 7 and 11, wherein a symbol index starts from 0.

In an embodiment, indexes of resource elements (REs) occupied by the first reference signal in a resource block (RB) are 0, 4, and 8, wherein an RE index starts from 0.

In an embodiment, indexes of REs occupied by the first reference signal in an RB is 0, 2, 4, 6, 8, and 10, wherein an RE index starts from 0.

In an embodiment, indexes of REs occupied by the first reference signal in an RB is 0, 1, 2, 3, 4, 5, 6, 7, 8, 9, 10, and 11, wherein an RE index starts from 0.

In an embodiment, the first reference signal is a physical broadcast channel demodulation reference signal (PBCH DMRS), and the second reference signal is a secondary synchronization signal (SSS).

In an embodiment, M=2, and N=3.

In an embodiment, in a slot, symbol indexes of the first reference signal are 4 and 8, 5 and 9, 6 and 10, or 7 and 13, wherein a symbol index starts from 0.

In an embodiment, indexes of REs occupied by the first reference signal in an RB are 1, 5 and 10, wherein an RE index starts from 0.

In an embodiment, indexes of REs occupied by the first reference signal in an RB is 1, 3, 5, 7, 10 and 12, wherein an RE index starts from 0.

In an embodiment, indexes of REs occupied by the first reference signal in an RB is 0, 1, 2, 3, 4, 5, 6, 7, 8, 9, 10, and 11, wherein an RE index starts from 0.

In an embodiment, the first reference signal is a tracking reference signal (TRS).

In an embodiment, M=1, and N=0.

In an embodiment, in a slot, symbol indexes of the first reference signal are 6, 7, 8, 9, 10, 11, 12, and 3, wherein a symbol index starts from 0.

In an embodiment, in a slot, symbol indexes of the first reference signal are 4, 5, 6, 7, 8, 9, 10, and 11, wherein a symbol index starts from 0.

In an embodiment, M=2, and N=0.

In an embodiment, in a slot, symbol indexes of the first reference signal are 4 and 5, 6 and 7, 8 and 9, or 10 and 11, wherein a symbol index starts from 0.

In an embodiment, the first reference signal is a secondary synchronization signal (SSS).

In an embodiment, the first reference signal occupies 20 resource blocks (RBs).

For more detailed description of the receiving unit 301, reference may be directly made to the related description of the terminal device in the method embodiment illustrated in FIG. 2, which will not be described in detail herein again.

FIG. 4 is a schematic structural diagram of another communication device provided in an embodiment of the present disclosure. The device may be a network device or a module (for example, a chip) in the network device. As illustrated in FIG. 4, the communication device 400 at least includes a sending unit 401. The sending unit 401 is configured to send a first reference signal, wherein the first reference signal occupies M symbols, the M symbols are spaced apart by N symbols, M is an integer greater than 0, and N is an integer greater than or equal to 0

In a possible embodiment, M=2, and N=1.

In a possible embodiment, in a slot, symbol indexes of the first reference signal are 2 and 4, 5 and 7, 8 and 10, or 11 and 13, wherein a symbol index starts from 0.

In a possible embodiment, in a slot, symbol indexes of the first reference signal are 0 and 2, or 3 and 5, or 6 and 8, or 9 and 11, wherein a symbol index starts from 0.

In a possible embodiment, there is a second reference signal between two symbols of the first reference signal.

In a possible embodiment, in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0.

In a possible embodiment, in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

In a possible embodiment, in a slot, symbol indexes of the first reference signal are 3 and 5, 6 and 8, or 9 and 11, wherein a symbol index starts from 0.

In a possible embodiment, in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

In a possible embodiment, in a slot, symbol indexes of the first reference signal are 2 and 4, 3 and 5, 8 and 10, or 9 and 11, wherein a symbol index starts from 0.

In a possible embodiment, in a slot, symbol indexes of the first reference signal are 4 and 8, 5 and 9, 6 and 10, or 7 and 11, wherein a symbol index starts from 0.

In a possible embodiment, indexes of resource elements (REs) occupied by the first reference signal in a resource block (RB) are 0, 4, and 8, wherein an RE index starts from 0.

In a possible embodiment, indexes of REs occupied by the first reference signal in an RB is 0, 2, 4, 6, 8, and 10, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a physical broadcast channel demodulation reference signal (PBCH DMRS), and the second reference signal is a secondary synchronization signal (SSS).

In a possible embodiment, M=2, and N=3.

In a possible embodiment, in a slot, symbol indexes of the first reference signal are 4 and 8, 5 and 9, 6 and 10, or 7 and 13, wherein a symbol index starts from 0.

In a possible embodiment, indexes of REs occupied by the first reference signal in an RB are 1, 5 and 10, wherein an RE index starts from 0.

In a possible embodiment, indexes of REs occupied by the first reference signal in an RB is 1, 3, 5, 7, 10 and 12, wherein an RE index starts from 0.

In a possible embodiment, indexes of REs occupied by the first reference signal in an RB is 0, 1, 2, 3, 4, 5, 6, 7, 8, 9, 10, and 11, wherein an RE index starts from 0.

In a possible embodiment, the first reference signal is a tracking reference signal (TRS).

In a possible embodiment, M=1, and N=0.

In a possible embodiment, in a slot, symbol indexes of the first reference signal are 6, 7, 8, 9, 10, 11, 12, 13, wherein a symbol index starts from 0.

In a possible embodiment, in a slot, symbol indexes of the first reference signal are 4, 5, 6, 7, 8, 9, 10, 11, wherein a symbol index starts from 0.

In a possible embodiment, M=2, and N=0.

In a possible embodiment, in a slot, symbol indexes of the first reference signal are 4 and 5, 6 and 7, 8 and 9, or 10 and 11, wherein a symbol index starts from 0.

In a possible embodiment, the first reference signal is a secondary synchronization signal (SSS).

In a possible embodiment, the first reference signal occupies 20 resource blocks (RBs).

For more detailed description about the sending unit 401, reference may be directly made to the related description about the network device in the method embodiment illustrated in FIG. 2, which is not further described herein.

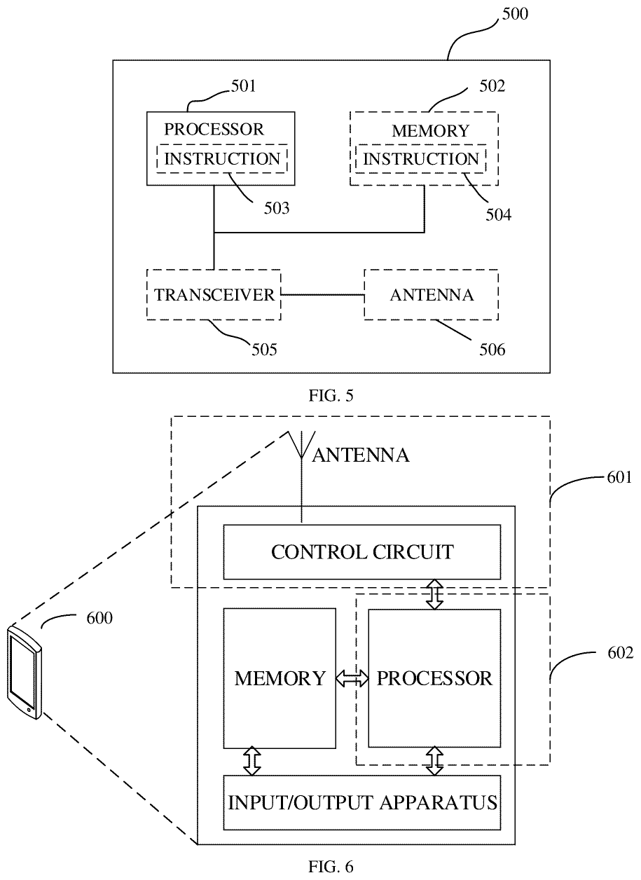

Based on the foregoing network architecture, reference is made to FIG. 5, which is a schematic structural diagram of another communication device provided in an embodiment of the present disclosure. As illustrated in FIG. 5, the device 500 may include one or more processors 501. The processor 501 may also be referred to as a processing unit, and may implement certain control functions. The processor 501 may be a general-purpose processor, a dedicated processor, or the like, such as a baseband processor or a central processing unit (CPU). The baseband processor may be configured to process a communication protocol and communication data, and the CPU may be configured to control a communication device (such as a base station, a baseband chip, a terminal, a terminal chip, a DU or a CU, executing a software program, and processing data of the software program.

In an optional design, the processor 501 may also store an instruction and/or data 503, where the instruction and/or data 503 may be run by the processor, so that the device 500 executes the method described in the foregoing method embodiments.

In another optional design, the processor 501 may include a transceiver unit configured to implement a transmit/receive function. For example, the transceiver unit may be a transceiver circuit, an interface, an interface circuit, or a communications interface. A transceiver circuit, an interface, or an interface circuit configured to implement a receive function and a transceiver circuit, an interface, or an interface circuit configured to implement a transmit function may be separate, or may be integrated together. The transceiver circuit, the interface, or the interface circuit may be configured to read and write code/data, or the transceiver circuit, the interface, or the interface circuit may be configured to transmit or transfer a signal.

In yet another possible design, the device 500 may include a circuit, where the circuit may be configured to implement a function of sending, receiving, or communicating in the foregoing method embodiments.

Optionally, the device 500 may include one or more memories 502. The one or more memories 502 store an instruction 504 thereon, the instruction may be run on the processor, so that the device 500 executes the method described in the foregoing method embodiments. Optionally, the one or more memories 502 may further store data. Optionally, the processor may also store an instruction and/or data. The one or more processors and the one or more memories may be separately disposed or integrated. For example, a correspondence described in the foregoing method embodiments may be stored in the one or more memories 502, or stored in the one or more processor 501.

Optionally, the device 500 can further include a transceiver 505 and/or an antenna 506. The processor 501 may be referred to as processing unit, and configured to control the device 500. The transceiver 505 may be referred to as a transceiver unit, a transceiver, a transceiver circuit, a transceiver apparatus, a transceiver module, or the like, and is configured to implement a transmit/receive function.

Optionally, the device 500 in the embodiment of the present disclosure may be configured to execute the method described the embodiment of the present disclosure as illustrated in FIG. 2 in.

In an embodiment, the communication device 500 may be a terminal device, or may be a module (for example, a chip) in the terminal device. When the computer program instruction stored in the memory 502 is executed, the transceiver 505 is configured to execute operations executed by the receiving unit 301 in the foregoing embodiment. The transceiver 505 is further configured to send information to another communication device except the communication device. The terminal device or the module in the terminal device may be further configured to execute various methods executed by the terminal device in the foregoing method embodiments illustrated in FIG. 2, which will not be described herein in detail.

In an embodiment, the communication device 500 may be a network device, or may be a module (for example, a chip) in the network device. When the computer program instruction stored in the memory 502 is executed, the transceiver 505 is configured to execute operations executed by the sending unit 401 in the foregoing embodiment. The transceiver 505 is further configured to send information to another communication device except the communication device. The foregoing network device or the module in the network device may be further configured to execute various methods executed by the network device in the foregoing method embodiment, which will not be described herein in detail.

The processor and transceiver described herein may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be manufactured using various IC process technologies, such as complementary metal oxide semiconductor (CMOS), N-type metal-oxide-semiconductor (NMOS), positive channel metal oxide semiconductor (PMOS), bipolar junction transistor (BJT), bipolar-CMOS (BiCMOS), silicon germanium (SiGe), gallium arsenide (GaAs), or the like.

The device described in the foregoing embodiment may be a network device or a terminal device, but the scope of the device described in the present disclosure is not limited thereto, and the structure of the device is not limited to FIG. 5. The device may be a stand-alone device or may be part of a larger device. For example, the device may be: an independent IC, a chip, a chip system, or a subsystem; a set of one or more ICs, and optionally, the set of one or more ICs can also include a storage component for storing data and/or instructions; an ASIC such as a modem (e.g., mobile station modem (MSM)); a module that can be embedded within other devices; a receiver, a terminal, a smart terminal, a cellular phone, a wireless device, a handset, a mobile unit, a vehicle-mounted device, a network device, a cloud device, an artificial intelligence (AI) device, a machine device, a home device, a medical device, an industrial device, etc.; and others, etc.

FIG. 6 is a schematic structural diagram of a terminal device provided in an embodiment of the present disclosure. For case of description, FIG. 6 only illustrates main components of the terminal device. As illustrated in FIG. 6, the terminal device 600 includes a processor, a memory, a control circuit, an antenna, and an input/output apparatus. The processor is mainly configured to process a communication protocol and communication data, control the whole terminal, execute a software program, and process data of the software program. The memory is mainly configured to store a software program and data. A radio frequency (RF) circuit is mainly configured for conversion between a baseband signal and an RF signal and process the RF signal. The antenna is mainly configured to receive/transmit an RF signal in the form of an electromagnetic wave. The input/output apparatus, such as a touchscreen, a display screen, and a keyboard, is mainly configured to receive data input by a user and output data to the user.

After the terminal device is powered on, the processor may read the software program in a storage unit, parse and execute an instruction of the software program, and process data of the software program. When data needs to be sent wirelessly, after performing baseband processing on the data to be sent, the processor outputs a baseband signal to the RF circuit. The RF circuit processes the baseband signal to obtain an RF signal, and sends the RF signal outwards in the form of an electromagnetic wave via the antenna. When data is sent to the terminal, the RF circuit receives the RF signal via the antenna, the RF signal is further converted into a baseband signal, and the baseband signal is output to the processor. The processor converts the baseband signal into data and processes the data.

For case of description, FIG. 6 only illustrates one memory and processor, and in an actual terminal device, multiple processors and multiple memories may exist. The memory may also be referred to as a storage medium or a storage device, which is not limited in embodiments of the present disclosure.

As an optional embodiment, the processor may include a baseband processor and a CPU, where the baseband processor is mainly configured to process a communication protocol and communication data, and the CPU is mainly configured to control the whole terminal, execute a software program and process data of the software program. Functions of the baseband processor and the CPU are integrated into the processor in FIG. 6. It can be understood by a person skilled in the art that the baseband processor and the CPU may also be independent processors, and are interconnected through technologies such as a bus. It can be understood by a person skilled in the art that a terminal may include multiple baseband processors to adapt to different network standards, the terminal may include multiple CPUs to enhance the processing capability thereof, and various components of the terminal may be connected via various buses. The baseband processor may also be referred to as a baseband processing circuit or a baseband processing chip, and the CPU may also be expressed as a central processing circuit or a central processing chip. Functions of processing the communication protocol and the communication data may be built in the processor, or may be stored in the storage unit in the form of a software program, and the processor executes the software program to implement the baseband processing function.

In an example, the antenna having a transmit/receive function and the control circuit may be considered as the transceiver unit 601 of the terminal device 600, and a processor having a processing function may be considered as the processing unit 602 of the terminal device 600. As illustrated in FIG. 6, the terminal device 600 includes a transceiver unit 601 and a processing unit 602. The transceiver unit 601 may also be referred to as a transceiver, a transceiver device, a transceiver apparatus, or the like. Optionally, a component configured to implement a receiving function in the transceiver unit 601 may be considered as a receiving unit, and a component configured to implement a sending function in the transceiver unit 601 may be considered as a sending unit, that is, the transceiver unit 601 includes a receiving unit and a sending unit. Exemplarily, the receiving unit may also be referred to as a receiving device, a receiver, a receiving circuit, or the like, and the sending unit may be referred to as a transmitting device, a transmitter, a transmitting circuit, or the like. Optionally, the receiving unit and the sending unit may be integrated into one unit, and may also be multiple units independent of each other. The receiving unit and the sending unit may be in a single geographical location, and may also be distributed in multiple geographical locations.

In an embodiment, the transceiver unit 601 is configured to perform operations performed by the receiving unit 301 in the foregoing embodiment. The terminal device 600 may also be configured to execute various methods executed by the terminal device in the method embodiment as illustrated in FIG. 2, which will not be repeatedly described in detail herein.

Embodiments of the present disclosure further provide a computer-readable storage medium. The computer-readable storage medium stores a computer program thereon which, when executed by a processor, is configured to implement processes related to the terminal device in a communication method provided in the foregoing method embodiments.

Embodiments of the present disclosure further provide a computer-readable storage medium. The computer-readable storage medium stores a computer program thereon which, when executed by a processor, is configured to implement processes related to the network device in a communication method provided in the foregoing method embodiments.

Embodiments of the present disclosure further provide a computer program product. When the computer program product is run on a computer or a processor, the computer or the processor is enabled to execute one or more operations of any one of the foregoing communication methods. If various modules of the above devices are implemented as software functional units and sold or used as standalone products, the software functional units may be stored in a computer-readable storage medium.

Embodiment of the present disclosure further provide a chip system. The chip system includes at least one processor and a communication interface. The communication interface and the at least one processor are interconnected via a line, and the at least one processor is configured to run a computer program or an instruction, so as to execute part or all of the operation of any one method in the method embodiments corresponding to FIG. 2. The chip system may consist of a chip, and may also consist of a chip and other discrete components.

A communication system is further provided in embodiments of the present disclosure. The system includes a terminal device and a network device. For specific description, reference may be made to the communication method illustrated in FIG. 2.

It should be understood that the memory involved in embodiments of the present disclosure may be a volatile memory or a non-volatile memory, or may include both volatile and non-volatile memories. The non-volatile memory may be a hard disk drive (HDD), a solid-state drive (SSD), a read-only memory (ROM), a programmable read-only memory (PROM), an erasable PROM (EPROM), an electrically EPROM (EEPROM), or a flash memory. The volatile memory may be random access memory (RAM), which serves as an external cache. By way of example and not limitation, many forms of RAM are available, such as static RAM, static RAM (SRAM), a dynamic RAM (DRAM), a synchronous DRAM (SDRAM), and a double data rate SDRAM (DDR SDRAM), an enhanced SDRAM (ESDRAM), and a synchronous-link DRAM (SLDRAM) and a direct rambus bus RAM (DR RAM). The memory is a medium that can be used to carry or store desired program codes in the form of instructions or data structures and can be accessed by a computer, but is not limited thereto. The memory in embodiments of the present disclosure may also be a circuit or any other devices capable of storing, and is configured to store a program instruction and/or data.

It may be noted that, the processor involved in embodiments of the present disclosure may be a central processing unit (CPU), or may be other general-purpose processors, a digital signal processor (DSP), an application specific integrated circuit (ASIC), a field-programmable gate array (FPGA), or other programmable logic devices, discrete gates or transistor logic devices, discrete hardware components, and the like. The general-purpose processor may be a microprocessor, or the processor may also be any conventional processor.

It can be noted that, when the processor is a general-purpose processor, a DSP, an ASIC, an FPGA, or other programmable logic devices, discrete gates or transistor logic devices, discrete hardware components, the memory (storage module) is integrated into the processor.

It can be noted that the memory described herein is intended to include, but is not limited to, these and any other suitable types of memories.

It may be understood that, in various embodiments described herein, the magnitude of a sequence number of each process does not mean an order of execution, and the order of execution of each process should be determined by its function and internal logic and shall not constitute any limitation to an implementation process of embodiments of the present disclosure.

Those of ordinary skill in the art will appreciate that the units and algorithm steps of the various examples described in connection with the embodiments disclosed herein can be implemented in electronic hardware or a combination of computer software and electronic hardware. Whether these functions are performed in hardware or software depends on the specific application and design constraints of the technical solution. A person skilled in the art can use different method to implement the described functions for each particular application, but such implementation should not be considered to be beyond the scope of the present disclosure.

A person skilled in the art can clearly understand that, for the convenience and brevity of the description, the specific working process of the systems, the devices and the units described above may refer to the corresponding processes in the foregoing method embodiments, and details are not described herein again.

It will be appreciated that the systems, devices, and methods disclosed in embodiments herein may also be implemented in various other manners. For example, the above device embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise. Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

Various functional units described in embodiments herein may be integrated into one processing unit or may be present as a number of physically separated units, and two or more units may be integrated into one. The integrated unit may take the form of hardware or a software functional unit.

If functions are implemented as software functional units and sold or used as standalone products, they may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computing device, e.g., a personal computer, a server, a network device, etc., or a processor to execute some or all operations of the methods described in various embodiments. The above storage medium may include various kinds of media that can store program codes, such as a universal serial bus (USB) flash disk, a mobile hard drive, a read-only memory (ROM), a random access memory (RAM), a magnetic disk, or an optical disk.

Steps in methods in embodiments of the present disclosure may be adjusted sequentially, combined, and deleted according to actual requirements.

Modules in a device in embodiments of the present disclosure may be combined, divided, and deleted according to actual requirements.

The foregoing embodiments are merely intended for describing technical solutions of the present disclosure rather than limiting the present disclosure. Although the present disclosure is described in detail with reference to the foregoing embodiments, persons of ordinary skill in the art should understand that modifications to the technical solutions described in the foregoing embodiments, or equivalent replacements to some or all technical features of the technical solutions can still be made. These modifications or replacements do not make the essence of corresponding technical solutions depart from the scope of the technical solutions of embodiments of the present disclosure.

1. A communication method, comprising:
receiving a first reference signal, wherein the first reference signal occupies M symbols, the M symbols are spaced apart by N symbols, M is an integer greater than 0, and N is an integer greater than or equal to 0.

2. The method of claim 1, wherein M=2, and N=1.

3. The method of claim 2, wherein in a slot, symbol indexes of the first reference signal are 2 and 4, 5 and 7, 8 and 10, or 11 and 13, wherein a symbol index starts from 0; or in a slot, symbol indexes of the first reference signal are 0 and 2, or 3 and 5, or 6 and 8, or 9 and 11, wherein a symbol index starts from 0.

4. (canceled)

5. The method of claim 2, wherein there is a second reference signal between two symbols of the first reference signal;
wherein in a slot, symbol indexes of the first reference signal are 2 and 4, and a symbol index of the second reference signal is 3; or the symbol indexes of the first reference signal are 5 and 7, and the symbol index of the second reference signal is 6; or the symbol indexes of the first reference signal are 8 and 10, and the symbol index of the second reference signal is 9; or the symbol indexes of the first reference signal are 11 and 13, and the symbol index of the second reference signal is 12; wherein a symbol index starts from 0; or
wherein in a slot, symbol indexes of the first reference signal are 0 and 2, and a symbol index of the second reference signal is 1; or the symbol index of the first reference signal are 3 and 5, and the symbol index of the second reference signal is 4; or the symbol indexes of the first reference signal are 6 and 8, and the symbol index of the second reference signal is 7; or the symbol indexes of the first reference signal are 9 and 11 and the symbol index of the second reference signal is 10; wherein a symbol index starts from 0.

6-7. (canceled)

8. The method of claim 2, wherein in a slot, symbol indexes of the first reference signal are 3 and 5, 6 and 8, or 9 and 11, wherein a symbol index starts from 0.

9. The method of claim 2, wherein there is a second reference signal between two symbols of the first reference signal; and in a slot, symbol indexes of the first reference signal are 3 and 5, and a symbol index of the second reference signal is 4; or the symbol indexes of the first reference signal are 6 and 8, and the symbol index of the second reference signal is 7; or the symbol indexes of the first reference signal are 9 and 11, and the symbol index of the second reference signal is 10, wherein a symbol index starts from 0.

10. The method of claim 2, wherein in a slot, symbol indexes of the first reference signal are 2 and 4, 3 and 5, 8 and 10, or 9 and 11, wherein a symbol index starts from 0; or
in a slot, symbol indexes of the first reference signal are 4 and 8, 5 and 9, 6 and 10, or 7 and 11, wherein a symbol index starts from 0.

11. (canceled)

12. The method of claim 2, wherein indexes of resource elements (REs) occupied by the first reference signal in a resource block (RB) are 0, 4, and 8, wherein an RE index starts from 0; or
indexes of REs occupied by the first reference signal in an RB is 0, 2, 4, 6, 8, and 10, wherein an RE index starts from 0; or
indexes of REs occupied by the first reference signal in an RB is 0, 1, 2, 3, 4, 5, 6, 7, 8, 9, 10, and 11, wherein an RE index starts from 0.

13-14. (canceled)

15. The method of claim 5, wherein the first reference signal is a physical broadcast channel demodulation reference signal (PBCH DMRS), and the second reference signal is a secondary synchronization signal (SSS).

16. The method of claim 1, wherein M=2, and N=3.

17. The method of claim 16, wherein in a slot, symbol indexes of the first reference signal are 4 and 8, 5 and 9, 6 and 10, or 7 and 13, wherein a symbol index starts from 0.

18. The method of claim 16, wherein indexes of REs occupied by the first reference signal in an RB are 1, 5 and 10, wherein an RE index starts from 0; or
indexes of REs occupied by the first reference signal in an RB is 1, 3, 5, 7, 10 and 12, wherein an RE index starts from 0; or
indexes of REs occupied by the first reference signal in an RB is 0, 1, 2, 3, 4, 5, 6, 7, 8, 9, 10, and 11, wherein an RE index starts from 0.

19-20. (canceled)

21. The method of claim 16, wherein the first reference signal is a tracking reference signal (TRS).

22. The method of claim 1, wherein M=1, and N=0.

23. The method of claim 22, wherein in a slot, symbol indexes of the first reference signal are 6, 7, 8, 9, 10, 11, 12, 13, wherein a symbol index starts from 0; or
in a slot, symbol indexes of the first reference signal are 4, 5, 6, 7, 8, 9, 10, 11, wherein a symbol index starts from 0.

24. (canceled)

25. The method of claim 1, wherein M=2, and N=0.

26. The method of claim 25, wherein in a slot, symbol indexes of the first reference signal are 4 and 5, 6 and 7, 8 and 9, or 10 and 11, wherein a symbol index starts from 0.

27. The method of claim 22, wherein the first reference signal is a secondary synchronization signal (SSS), and the first reference signal occupies 20 resource blocks (RBs).

28-58. (canceled)

59. A communication device, comprising a processor, a memory, and a transceiver, wherein the memory is configured to store instruction which, when invoked by the processor, is configured to:
receive a first reference signal, wherein the first reference signal occupies M symbols, the M symbols are spaced apart by N symbols, M is an integer greater than 0, and N is an integer greater than or equal to 0.

60. A non-transitory computer-readable storage medium, wherein the non-transitory computer-readable storage medium stores a computer program or a computer instruction which, when executed by a processor, is configured to:
receive a first reference signal, wherein the first reference signal occupies M symbols, the M symbols are spaced apart by N symbols, M is an integer greater than 0, and N is an integer greater than or equal to 0.

61. (canceled)
